(19) United States
(12) Patent Application Publication
(10) Pub. No.: US 2023/0126143 A1
(43) Pub. Date: Apr. 27, 2023

(54) SYSTEM AND METHOD FOR SIMPLIFIED CENTRALIZED REWARD HUB ACCOUNT CREATION

(71) Applicant: SMILE INC., Kitchener (CA)

(72) Inventors: Ashton Leigh Rankin, Kitchener (CA); Andrew James Pye, Kitchener (CA); Rafael Goulart do Rosario, Joinville (BR); Lucas de Oliveira Silva Arantes, Kitchener (CA); Zhenyi Zhang, Waterloo (CA); Jose Bento, Milton (CA); Dan Winer, Tarifa (ES); Matthew Hennessy, Kitchener (CA); Buraa Al Burghli, Milton (CA); Sivakumar Kailasam, Kitchener (CA); Edgar Alexander Willemsma, Kitchener (CA); Timothy Schmitke, Kitchener (CA); Ely Joaquin Alvarado Meza, Kitchener (CA); Nathaniel Lutz, London (CA)

(21) Appl. No.: 17/972,065

(22) Filed: Oct. 24, 2022

Related U.S. Application Data
(60) Provisional application No. 63/271,492, filed on Oct. 25, 2021.

(51) Int. Cl. G06Q 30/0226; G06Q 30/0207; G06Q 30/0214

(52) U.S. Cl. CPC G06Q 30/0233; G06Q 30/0236; G06Q 30/0214

(57) ABSTRACT

An example server includes: a memory storing an account database for a centralized reward hub; a processor interconnected with the memory, the processor configured to: receive purchase data for a purchase by a customer, the purchase data including a customer identifier; determine whether account database includes an existing entry corresponding to the customer identifier; when the account database does not include an existing entry corresponding to the customer identifier, create a new entry for the customer identifier; send the customer a login link for the centralized reward hub based on the new entry or the existing entry corresponding to the customer identifier.

### FIELD

The specification relates generally to e-commerce systems, and more particularly to simplified account creation for a centralized reward hub in an e-commerce system.

### BACKGROUND

E-commerce programs, commonly referred to as e-commerce platforms, allow users to shop at their merchant websites (“estore”) and there may be loyalty programs associated with the merchants. The users typically peruse the merchant websites, adding things to an online shopping cart typically until they are ready to “check-out,” in order to consummate their purchase. Upon completing their purchases, the user typically may also receive a notification of the reward points awarded from the purchase as well as their total accumulated reward points with the merchant. Typically, the users would join or become a member of the loyalty reward program in order to earn reward points when they purchase from the merchant who provides the loyalty reward program.

Ultimately, the purpose of the loyalty reward programs of merchants is to retain their customers or shoppers through many repeat purchases. This is accomplished by the shoppers redeeming their reward points (from previous purchases) when purchasing an item. For small and medium sized businesses (SMBs), the individual merchants are frequently not big enough for their customers to regularly redeem their reward points due the merchants' limited selection of products and services.

### SUMMARY

According to an aspect of the present specification an example server includes: a memory storing an account database for a centralized reward hub; a processor interconnected with the memory, the processor configured to: receive purchase data for a purchase by a customer, the purchase data including a customer identifier; determine whether account database includes an existing entry corresponding to the customer identifier; when the account database does not include an existing entry corresponding to the customer identifier, create a new entry for the customer identifier; send the customer a login link for the centralized reward hub based on the new entry or the existing entry corresponding to the customer identifier.

According to another aspect of the present specification, an example method includes: storing an account database for a centralized reward hub; receiving purchase data for a purchase by a customer, the purchase data including a customer identifier; determining whether account database includes an existing entry corresponding to the customer identifier; when the account database does not include an existing entry corresponding to the customer identifier, creating a new entry for the customer identifier; sending the customer a login link for the centralized reward hub based on the new entry or the existing entry corresponding to the customer identifier.

### BRIEF DESCRIPTION OF DRAWINGS

Implementations are described with reference to the following figures, in which:

FIG. 1 depicts a block diagram of an e-commerce system 100 according to an example embodiment of the present invention.

FIG. 2 depicts a flowchart implementing a part of a loyalty reward system in accordance with an example embodiment.

FIG. 3 is a flowchart depicting a part of Match 215 in an example implementation of FIG. 2.

FIG. 4 is a block diagram of a hub implemented in the system of FIG. 1 according to an example embodiment.

FIG. 5 is a schematic diagram of a web page displaying information by the hub of FIG. 4 according to an example embodiment.

FIG. 6 is a schematic diagram of a web page displaying combined information in the Combined Total section of FIG. 5 according to an example embodiment.

FIG. 7 is a schematic diagram of a web page for redemption from the collaborative section of FIG. 6 according to an example embodiment.

FIG. 8 is a flow chart depicting an example method of implementing a part of the Loyalty Rewards System in accordance with another example embodiment.

FIG. 9A is a Screenshot of the Link depicting a part of the message of Email in accordance with the embodiment of FIG. 8.

FIG. 9B is a screenshot of an Authentication Link depicting a part of the message of Email in accordance with the embodiment of FIG. 8.

FIG. 10 are screenshots of Website of the Hub in accordance with the embodiment of FIG. 8.

FIG. 11 is a screenshot of the Signed-in website of the Hub in accordance with the embodiment of FIG. 8.

FIG. 12 is a screenshot of a page at the website of the Store, the Merchant “Happy book store staging” store, in accordance with the embodiment of FIG. 11.

FIG. 13 is a flow chart depicting a Method 1300 of limiting users to certain loyalty reward programs in accordance with another example embodiment.

### DETAILED DESCRIPTION

Embodiments described herein provide enhanced computer- and network-based methods and systems of a Hub for viewing and utilizing loyalty reward programs. The hub may also be known as a customer portal or Dashboard. The functions of the Hub include acting as a loyalty rewards center for the customer or user to locate their rewards information associated with loyalty reward programs that which they have accounts or are members thereof. For example, their accounts may be located from their email address(es) across all merchants within a platform which manages loyalty reward programs of the merchants.

The Hub has functions which further include acting as a shopping center where the customer may discover merchants and their stores with products and services of interest to them. These discovered merchants include merchants where the customer may use rewards or reward points from one merchant with one loyalty rewards program at another merchant with another loyalty reward program. These discovered merchants' websites may also be accessed from the Hub to purchase products and services.

The Hub may be a software program running on a server which can be accessed over the Internet at a website from a browser or from an application running on a computing device. The application may be a client of the Hub.

For customers, the Hub functions include listing the overall status of rewards for all merchants associated with the Hub where the customer has made purchases/earned points, or redeemed points for rewards, including: reward point balances, a list of redeemed rewards (coupon codes, etc) with usage status (available, used, etc), referral links and usage, VIP tier statuses and info (like expiry times), rewards available to redemption, and a search function (hereinafter referred to as Discovery) to discover merchants having products and services for which the customer's rewards and reward points may be used.

For merchants, the functions of the Hub include providing a directory of merchants who permits their reward points (from their loyalty reward programs) to be used or redeemed at other merchants listed in the directory, and providing advertising opportunities for merchants to promote their business. The Hub may also list merchants who do not permit their reward points (from their loyalty reward programs) to be used or redeemed at other merchants listed in the directory.

It would be advantageous for SMBs to collaborate in allowing the reward points earned at other merchants to be used in a merchant's e-store. It would be advantageous for a system and method for viewing and utilizing loyalty reward programs of merchants where a customer has earned reward points. Further, with many SMBs, it would be advantageous for customers to be able to discover other merchants who are willing to allow them to use their earned reward points.

There are a number of methods to identify and/or track customers or users such as by telephone numbers and email addresses. Identifiers of a user comprise one or more of the following: name of a person or entity, telephone number, text messaging identifier, email address, payment information, physical address, delivery address, billing address, IP address, advertising ID, device ID, customer ID, social network ID, payment wallet, digital wallet, and such other contact information as may be used or developed.

E-commerce platforms, such as SHOPIFY, support merchants going online to sell their products and services. Some of the e-commerce platforms further provide tracking or matching of the registered users and guest users on merchant websites. For example, a customer identifier (customer ID), for example a number, is assigned to each new guest when a purchase is made at a merchant's website. The e-commerce platform would assign the same custom ID to the same guest, where detected as the same guest, for a subsequent transaction or purchase. For example, a transaction record (such as for a purchase) in the accounts of the merchant as provided by the e-commerce merchant may include customer ID, details of the purchase, date, and amount. Where the guest is matched to an existing guest, the previously assigned customer ID is used. The matching algorithms of the e-commerce platforms may include payment information, telephone number, and email address of the guest. This matching or association of guests to their transactions is generally accurate enough to allow a loyalty rewards program to grant reward points for the guests in the records of the merchant. For example, the merchant can grant and accumulate reward points for their guest users using the customer ID provided by their e-commerce platform. The merchant records would grant the reward points based on a guest's purchase(s). The granted reward points would then be added to the reward points associated with the customer ID in the merchant's records.

The customer ID from some e-commerce platforms may also be associated with other identifiers of the purchaser like the purchaser's name, telephone number and email address. For example, some customer IDs may only be associated with a name and telephone number. Other customer IDs may only have a name and email address. Some other customer IDs may only have just an email address. The number of possible combinations of associations with an example purchaser is very large and may further change over time. For example, a purchaser may change their telephone number, physical address, or email address. A purchaser's identifiers may have more than one telephone number, email address, etc. A purchaser's identifiers may also be transferred to other purchasers for various reasons such as a telephone number transferring to another purchaser.

The identifiers which may identify (or associate with) a guest user may be highly complex. It is thus advantageous to use a guest matching service, which may provide customer IDs, as provided by some e-commerce platforms along with some example identifiers like telephone numbers and email addresses which can further be used to authenticate the guest or guests.

Once a guest user is identified by various means including the techniques noted in this document, technical means may also be used to continuously track when the guest user visits a merchant website using the same computing device. For example, cookies (as is commonly known) or information packets may be used where the guest user may be identified when visiting a merchant's website. Similarly, a user with a registered account may be automatically signed into the account when visiting a merchant's website using known methods.

In addition to purchases of products or services, reward points may also be earned for other activities such as referring another user to a merchant, providing a review on a social network for the merchant, and creating an account with the merchant.

The description herein provides a loyalty reward system comprising a hub for a customer to manage their reward points in the loyalty reward program of more than one merchant. In one embodiment, the hub comprises exchanging and transferring the reward points earned at one merchant to those of another merchant. In another embodiment, the hub provides group accounts. In another embodiment, the hub provides a combined total of reward points using one of a currency and points. In another embodiment, the hub searches for a customer's accounts at merchants using customer identifiers.

The description herein further provides a method comprising searching for reward points of a customer at more than one loyalty reward program using a hub. In one embodiment, the method comprises managing the reward points at more than one loyalty reward program through the hub. In another embodiment, the method comprises exchanging and transferring the reward points earned at one merchant to those of another merchant through the hub. In another embodiment, the method comprises providing group accounts through the hub. In another embodiment, the method comprises providing a combined total of reward points using one of a currency and points through the hub. In another embodiment, the method comprises searching for a customer's accounts at merchants using customer identifiers through the hub.

The description herein further provides a loyalty reward system comprising a hub for exchanging and transferring the reward points earned at one merchant to those of another merchant. In one embodiment, the hub further provides a combined total of reward points using one of currency and points. In another embodiment, the hub further comprises converting the points of one merchant to those of another merchant.

The description herein further provides a method comprising exchanging and transferring the reward points earned at one merchant to those of another merchant using a hub. In one embodiment, the method further comprises the hub providing a combined total of reward points using one of currency and points. In another embodiment, the method further comprises the hub converting the points of one merchant to those of another merchant.

The description herein further provides a loyalty reward system comprising a hub for exchanging and transferring the reward points earned at one merchant to those of another merchant. In one embodiment, the hub further provides a combined total of reward points using one of currency and points. In another embodiment, the hub further converts the points of one merchant to those of another merchant. In another embodiment, the hub further selects the points at selected merchants for conversion to those of another merchant.

The description herein further provides a method comprising exchanging and transferring the reward points earned at one merchant to those of another merchant using a hub. In one embodiment, the hub further provides a combined total of reward points using one of currency and points. In another embodiment, the hub further provides conversion of points of one merchant to those of another merchant. In another embodiment, the hub further provides the selection of points at selected merchants for conversion to those of another merchant.

The description herein further provides a loyalty reward system comprising a hub for a customer to manage their reward points in the loyalty reward program of more than one merchant where the customer accesses the Hub from a link in a message. The link may be contained in one of an email message and a text message. The link may have an authentication code to sign into the account of the customer at the Hub.

The description herein further provides a method comprising a customer accessing a Hub of a loyalty reward system from a link in a message where the hub provides for the customer to manage their reward points in loyalty reward programs of more than one merchant. The link may be contained in one of an email message and a text message. The link may have an authentication code to sign into the account of the customer at the Hub.

The description herein further provides a loyalty reward system comprising a hub for a customer to redeem their reward points of one loyalty reward program from one merchant at a website of another merchant with another loyalty reward program. The website of another merchant with another loyalty reward program is accessed from a link at the hub. The link may have an authentication code to sign into the account of the customer at the other merchant.

The description herein further provides a method for a customer to redeem their reward points of one loyalty reward program from one merchant at a website of another merchant with another loyalty reward program using a loyalty reward system. The website of another merchant with another loyalty reward program is accessed from a link at the hub. The link may have an authentication code to sign into the account of the customer at the other merchant.

The description herein further provides a loyalty reward system comprising a hub for creating an account with a loyalty reward program wherein a customer accesses the loyalty reward system to input their information and selects the loyalty reward program from a listing of loyalty reward programs to create the account with the loyalty reward program. The list may comprise loyalty reward programs having their place of business within the same geographic location as the customer. The list may comprise loyalty reward programs having compliance with legal requirements for customers within the same geographic location as the customer.

The description herein further provides a method of creating an account with a loyalty reward program comprising a customer accessing a loyalty reward system to input their information and selecting the loyalty reward program from a listing of loyalty reward programs to create the account with the loyalty reward program. The list may comprise loyalty reward programs having their place of business within the same geographic location as the customer. The list may comprise loyalty reward programs having compliance with legal requirements for customers within the same geographic location as the customer.

As used herein, the term “merchant” is intended to be broadly construed to mean any type of seller, dealer, retailer, distributor, or store owner or operator, including a non-profit organization. The term “product” is intended to be broadly construed to mean any type of goods and/or services. The term “application” is intended to be broadly construed to mean any type of software product, whether delivered by download, storage device, or otherwise, whether an integrally provided component of the ecommerce platform or separately provided for integration and use therewith, and/or whether stored remotely and accessed over a communications network or stored locally. The term “loyalty reward system” or “loyalty rewards platform” is intended to be broadly construed to mean an application providing the essential functionality described and claimed herein. The term “ecommerce platform” is intended to be broadly construed to mean any type of software technology solution that (a) provides merchant-facing backends that enable merchants to customize and manage customer-facing storefronts on their websites for selling their products to their customers and (b) has an API or other interface for working with the recurrence application as described herein (as such, the terms “application” and “platform” are used interchangeably herein with respect to the ecommerce software, and any distinction between these terms is not considered important to a full understanding of the invention). As used herein, the terms “customer” and “user” are intended to be interchangeably herein and are to be intended broadly construed to mean the customers of the merchants. As used herein, the term “reward points” are intended to be construed to mean points of a loyalty reward program, but are also intended to mean currency (such $5.00 dollars) as some loyalty reward programs may issue currency amounts instead of points or in combination with points.

It will be appreciated that although example embodiments are shown and described in conjunction with the SHOPIFY platform, the Loyalty reward system application can be implemented for use with other ecommerce platforms and may also be used with servers or computers of merchants directly where the ecommerce platform functions are handled by the servers or computers of merchants. The functions of the Loyalty reward system, the merchant computer, and the ecommerce platforms are implemented in software and, as such, this software may be executed on any number of different computers, servers, and platforms without leaving the scope of this invention.

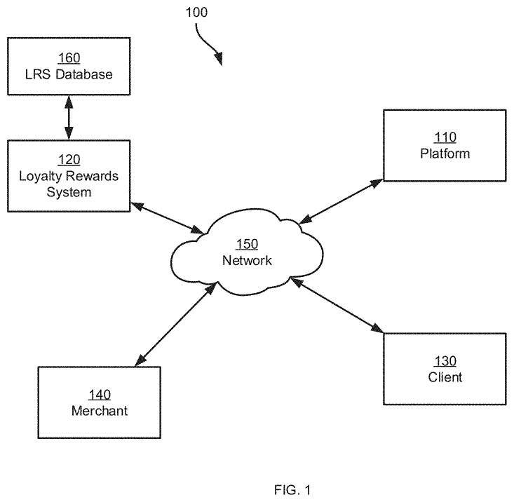

FIG. 1, there is shown a block diagram depicting an Ecommerce System 100 according to an example embodiment of the invention.

The E-commerce System 100 includes a Platform 110, a Loyalty Rewards System 120, a Client 130, and a Merchant 140. The E-commerce System 100 may further include a communications network 150 over which the Platform 110, the Loyalty reward system (LRS) 120, the Client 130 and the Merchant 140 may communicate.

The communications network 150 may be the Internet or another suitable communications network. For example, the network 150 can include a telecommunications network, a local area network (LAN), a wide area network (WAN), an intranet, an Internet, or any combination thereof. In an exemplary embodiment, the communication between the Loyalty Rewards System 120, the Platform 110, the Client 130, and the Merchant 140 can be encrypted to protect and secure the data communication between the systems. It will be appreciated that the network connections disclosed are exemplary and other means of establishing a communications link between the Loyalty Rewards System 120, the Platform 110, the Client 130, and the Merchant 140 can be used.

Although one Client 130 and one Merchant 140 are shown for ease of illustration, it should be appreciated that the system 100 may include any number of merchants and/or clients who can be served by the Platform 110 in the manner described herein. Similarly, although one Platform 110 is shown for ease of illustration, it should be appreciated that any number of platforms 110 can be included in the Ecommerce System 100.

While certain embodiments are described in which parts of the Ecommerce System 100 are implemented in software, it will be appreciated that one or more acts or functions of the loyalty award system may be performed by hardware, software, or a combination thereof, as may be embodied in one or more computing systems. For example, the Loyalty Rewards System 120, the Platform 110, the Client 130, and the Merchant 140 can be embodied as stand-alone application programs or as a companion program to a web browser having messaging and storage capabilities.

Each Platform 110 is an e-commerce platform of a particular company and may support e-commerce activities (e.g., sales, etc.) of a plurality of Merchants 140. The platform 110 may be implemented in a cloud-based and/or server-farm system, or another suitable computing device. For example, the platform 110 may include a server having a processor, communications interface and memory or other suitable computer-readable storage medium. The platform 110 may include an e-commerce platform application stored, for example, in the memory. In some examples, the e-commerce platform application may be a suite of distinct applications implementing the functionality described below. Further, the distinct applications may be located on separate but still connected/accessible servers. For example, the applications may call an e-commerce platform application program interface (API) using a hypertext transfer protocol (HTTP).

The e-commerce platform application may include computer-readable instructions, which when executed by the processor or other suitable processing device, enable the functionality described herein. It will be understood that the platform 110 performing, enabling or being configured for certain functionality may be achieved via execution of the computer-readable instructions stored in the application(s) by a processor.

In particular, the application(s) may enable the merchants 140 to run e-storefronts and/or websites, provide purchase processing capabilities, store customer account information, and the like. The applications can additionally provide for receiving, processing, and reconciling orders, billing, and inventory, and presenting such information to the Merchant 140, as well as other functionality to support the e-commerce activities of the Merchant 140. The application(s) may additionally support hosting an ecommerce storefront (e-storefront) for the Merchant(s) 140 and making the e-storefront interface accessible to the Client 130. The application(s) may additionally provide an interface to the Merchant 140 to customize rule sets for offering products for sale to the users (e.g. users accessing e-storefront from Clients 130), and accepting orders for such products.

The Platform 110 further provides functionality to assist the merchants in managing their e-storefront. The merchants are able to track their users', whether registered or not (i.e. guests), activities relating to their e-storefronts. For example, Platform 110 generates an event of each purchase order of a user from a merchant's e-storefront. The event is associated with the merchant and the user and is accessible by both parties for their records. A record of the event can include customer ID (of the user), guest or registered (whether the user has created an account with the merchant), telephone number (of the user), email address (of the user), product purchased, date of purchase, and payment amount. This short list of information relating to a record is for illustration only. Such records may typically contain more or less information.

In some platforms, the telephone number or email address (or any other identifiers) of the user may be used as the customer ID by the platform to identify the user. The Platform 110 may assign a new customer ID to an event if it is not able to match the user to an existing user. If it is able to match the user to an existing user, the Platform 110 will provide the customer ID of the user to their purchase order. A registered user will have already created an account (store account) with the merchant and if the purchase is made under their account then the record of the event will have their assigned customer ID. Where a guest user (who does not have an account) makes a purchase, the record of the event will have the customer ID either as newly assigned where there is no match to an existing guest user, or an existing customer ID where a match is detected based on the profile of an existing guest user (for example, the same email address is used by the guest user).

There are a number of e-commerce platform companies which could be represented by Platform 110 or Platforms 110. The description herein should be read to apply to one or more companies accordingly. For example, the Customer ID a user has with one company may not be the same as the Customer ID of the same user with another company unless the companies had agreed to standardize their Customer IDs.

The Platform 110 can also be configured to send a text message using a messaging service to confirm the events, e.g., purchase order, to the user's messaging address. The message address may be a telephone number for text messages, an email address for text messages, and any other messaging service. Messages on the reward points earned by the users may similarly be sent to the users whether they are guest users or registered users.

The Loyalty Reward System (LRS) 120 may further be configured to implement a loyalty reward program for merchants through their e-storefronts. The Loyalty Rewards System 120 is configured to create, collect, manage, and modify information associated with user loyalty rewards accounts. Information associated with a loyalty rewards account can include, for example, user identification information, user contact information, user purchase information, historical user information, a loyalty award amount (the reward points), and other information necessary for implementing the Loyalty Rewards System 120.

In some examples, the Loyalty Rewards System 120 may be implemented on a server or suite of servers separate from the Platform 110. For example, the Loyalty Rewards System 120 may include a server having a processor, communications interface and memory or other suitable computer-readable storage medium. The Loyalty Rewards System 120 may include a loyalty reward application stored in the memory. The loyalty reward application may include computer-readable instructions which when executed, configure the Loyalty Rewards System 120 to perform the functionality described herein. In some examples, the loyalty reward application may be a suite of distinct applications. Further, in some examples, part or all of the Loyalty Rewards System 120 may be integrated with and implemented by the Platform 110, for example to allow integration of modules of the Loyalty Rewards System 120 with merchant websites.

As used herein, it will be understood that the Loyalty Rewards System 120 being configured to perform various functionality may be achieved by execution of instructions in the loyalty reward application by a processor at a dedicated loyalty reward server, at the platform 110, or at another capable computing device.

The functionality described herein may be performed by the Loyalty Rewards System 120 in cooperation with the platform 110 (e.g., by communicating instructions and data therebetween) and/or directly by the Loyalty Rewards System 120 when the Loyalty Rewards System 120 is, for example, integrated with and implemented by the platform 110.

In providing the services to the user, the Loyalty Rewards System 120 is able to track what the user is doing at the Merchant 140, the merchant's website. The tracking includes receiving information on what items are in the user's shopping cart at any one time, and what page is the user accessing at the merchant's website at any given time such as whether the user is viewing the details of an item. This tracking may be carried out using known methods. The tracking may be integrated, for example, into the functionality implemented by the e-commerce platform application and communicated to the Loyalty Rewards System 120.

The Loyalty Rewards System 120 is further extendable to the web pages of the e-storefront in the form of an embedded application within the web pages. In particular, such embedded applications or modules may be implemented as applications on the Platform 110. Some embedded applications may be configured to provide a user interface for interacting with users and displaying data relevant to a user's loyalty rewards account. The interactions with the users further include presenting nudges to the user while the user is shopping anywhere on a website including viewing the cart, home page, and product pages. Further, the user may also be presented with action items such as click to use points, select what to redeem for in a panel, apply rewards to items in a cart, apply code, and click to view rewards.

The records of events are processed by the Loyalty Rewards System 120 and reward points are awarded for each of the events which are then added to the loyalty rewards accounts of the users. The loyalty rewards accounts are identified by their respective customer IDs for both guest users and registered users. The record of events processed by the Loyalty Rewards System 120 may additionally be stored in a LRS database 160.

The LRS Database 160 may be configured to store information including about each merchant (such as physical address), whether the merchant has joined Marketplace or collaboration where the reward points earned by the customers at each of the merchants may be redeemed at each of the other merchants, the merchant's customers, about each customer (such as customer ID, physical address, email address, and telephone number) whether registered with an account or not, the transaction history (such as purchase orders) of each of the customers, and the loyalty rewards transactions of each of the customers (such as reward points earn by transaction, and reward points redemptions for what rewards). The LRS database 160 may additionally track merchant subscription to various functions of the Loyalty Rewards System 120. For example, the LRS database 160 may track whether a merchant permits their reward points (from their loyalty reward programs) to be used and redeemed at other merchants listed in the directory, whether a merchant may permit the LRS 120 to offer new users their reward points for a welcome bonus to encourage new users to sign up for the LRS 120, and the like.

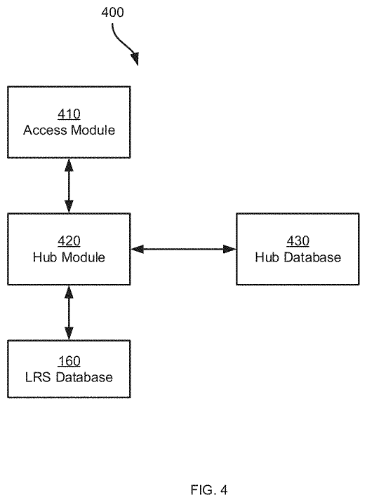

The Loyalty Rewards System 120 further comprises a Hub 400 (shown in FIG. 4). The Hub 400 may also be an application having computer-readable instructions and stored at the memory of the loyalty reward server. The Hub 400 may be accessible over the Internet at a website from a browser or from an application running on a computing device. In other examples, parts or all of the Hub 400 may be integrated with the Platform 110.

The functions of the Hub 400 include providing customers or users with a means to discover merchants including merchants where the customer may use rewards or reward points from one merchant with one loyalty rewards program at another merchant with another loyalty reward program.

The Hub 400 is further configured to act as a loyalty rewards center for the customer or user to locate their rewards information associated with loyalty reward programs that which they have accounts or are members thereof. For example, the Hub 400 may track hub accounts for a customer to log into the Hub 400 and view their Hub activities. The Hub 400 may additionally track, for each hub account, a set of associated customer accounts corresponding to one of the Merchants 140. For example, the customer accounts associated with a given hub account may be located based on corresponding email addresses used for both the hub account and the customer account at the merchant (i.e., on the Platform 110/in the Loyalty Rewards System 120).

The Hub 400 therefore centralizes the loyalty rewards across the set of associated customer accounts from a variety of different Merchants 140, and, as applicable, Platforms 110. More particularly, the Hub 400 may retrieve the associated loyalty rewards points for each respective customer account in the set of associated customer accounts. The loyalty rewards points can include a point balance, rewards available for redemption, and the like. The Hub 400 may then aggregate the associated loyalty rewards points, and output the aggregated associated loyalty rewards points for a user (e.g., at a client device being used to access the hub account). For example, aggregating the associated loyalty rewards points may include displaying the loyalty rewards points earned in association with each merchant (i.e., as separated by the customer account for each merchant).

For customers, the functions of the Hub 400 include listing the overall status of rewards for all merchants associated with the Hub 400 where the customer has made purchases/earned points, or redeemed points for rewards, including: reward point balances, a list of redeemed rewards (coupon codes, etc) with usage status (available, used, etc), referral links and usage, VIP tier statuses and info (like expiry times), rewards available to redemption, and a search function (hereinafter referred to as Discovery) to discover merchants having products and services for which the customer's rewards and reward points may be used.

The Hub 400 may additionally track loyalty rewards usage data for each respective customer account. The usage data may include the above data, such as redeemed rewards, usage status, referral links, VIP tier statuses and the like. The Hub 400 may then retrieve the associated loyalty rewards usage data and aggregate it for output to the user.

For merchants, the functions of the Hub 400 include providing a directory of merchants who permits their reward points (from their loyalty reward programs) to be used or redeemed at other merchants listed in the directory (i.e., a list of merchants permitting exchange of loyalty rewards points), and providing advertising opportunities for merchants to promote their business. The Hub 400 may also list merchants who do not permit their reward points (from their loyalty reward programs) to be used or redeemed at other merchants listed in the directory. For example, the Hub 400 may retrieve such information from the loyalty reward system database 160.

The client 130 is, for example, a computing device (e.g., laptop, desktop computer, mobile phone, tablet, kiosk, etc.) from which a user (who may be a shopper or customer) can access the Loyalty Rewards System 120, the platform 110 i.e., to access and interact with a website or e-storefront for the merchants 140 to, for example, purchase their products. Accordingly, the client 130 may additionally be referred to herein interchangeably as a client device 130.

The Merchant 140 is, for example, a computer from which a merchant can access and run their business through their e-storefront on the Platform 110. The merchant 140 may also therefore be referred to herein interchangeably as merchant device 140.

The Loyalty Rewards System 120, the Platform 110, the Client 130, and the Merchant 140 are in communication to provide the services to the user on the Client 130 as described herein.

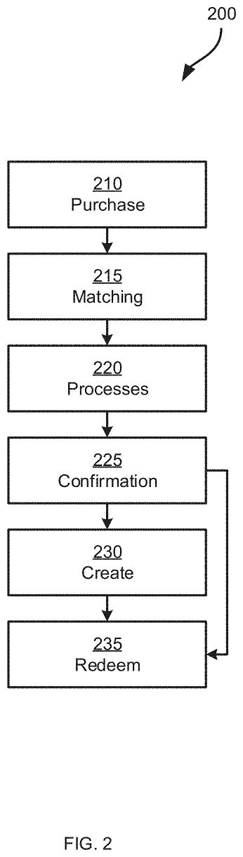

FIG. 2 is a flow chart depicting a Method 200 of implementing a part of the Loyalty Rewards System 120 in accordance with an example embodiment. The method 200 may be implemented in part or in whole by the Loyalty Rewards System 120, the Platform 110, or a combination of the two, or other suitable computing devices and/or systems. An example entry point into the Method 200 for a guest user starts with identifying the user (with for example a customer ID), for example by the Platform 110. Once identified (or signed in), the Loyalty Rewards System 120, through the nudge module, interacts with the user to further present nudges to the user while the user is shopping anywhere on a website including viewing the cart, home page, and product pages. Further, the Nudge module may also present users with action items such as click to use reward points, select what you to redeem for in a panel, click to apply reward to items in a cart, click to apply code, and click to view reward. The terms “click” and “select” are user actions and are used for clarity. They are not intended to limit the types of user interactions available with the Nudge module. The Nudge module may use any of the types of user interactions known in the art.

The user starts with a Purchase 210 of a product(s) from a Website of a Merchant Store (e.g., from an e-storefront serviced by the Platform 110). From the Client 130, the user selects the product(s) to purchase. The selected product(s) or item(s) to purchase may be added to what is commonly known as a shopping cart.

The Purchase 210, once submitted for checkout (a commonly known process), is received by the Platform 110 for Matching 215 to verify the customer ID (verification is optional), to obtain payment information and other information as is needed (for example, an email address), and to apply any discount or promotional codes. The Platform 110 fully Processes 220 the purchase once the user clicks to purchase or finally confirms such. A record of the event, this purchase, is updated for the merchant's account on the Platform 110. The step of verifying the customer ID is optional and may be skipped if the customer ID verification has sufficient accuracy such as when the user has signed into their account with the merchant in their purchase or such as when the customer ID is provided by the Platform 110 based on the user's provided information (such as the email address). The Processes 220 further includes providing this purchase event to the Loyalty Rewards System 120 so that reward points or rewards can be awarded to the user's account or the customer ID if the user is a guest user. The customer ID is effectively a loyalty award account in this example.

The customer ID may be verified to actually belong to the registered user or guest user by a number of known methods such as confirmation from an email sent to the user's email address.

A Confirmation 225 of the purchase is also sent to the user so that they may have a written confirmation of their purchase. Further, the Confirmation 225 includes a URL link as an invitation to the guest users to Create 230 a store account with the merchant so that the user (where it is a guest user) may become a registered user and be able to access their loyalty award account and to Redeem 235 their rewards accordingly. An example redemption of reward points is redeeming 100 reward points for a $10 discount code which the user can enter on their next purchase from the merchant for the discount.

Alternatively, the URL link of Confirmation 225 sent via email, or an unsecured messaging service, can initially point to Redeem 235 for redemption within a limited time period (for example one hour) and after the time period, the URL link can then point to Create 230.

Further alternatively, the URL link of Confirmation 225 sent via email, or an unsecured messaging service, can point to a web page indicating that a new URL link has been sent to the user's email address with Redeem 235 for redemption within a limited period (for example one hour). After the time period, this new URL link may be directed to the same web page indicating that another URL link has been sent to the user email address with Redeem 235 for redemption within a limited period (for example one hour). This cycle of emails and URL links may be repeated as authentication for users to access their loyalty award accounts to view and/or redeem their reward points. Other authentication methods may also be used, such Verification codes instead of URL links.

Where the Confirmation 225 has been sent to a guest user via a secured communications means such as via SMS to their telephone number, a URL link to Redeem 235 is included in the confirmation so that a guest user may accordingly redeem their reward points without becoming a registered user.

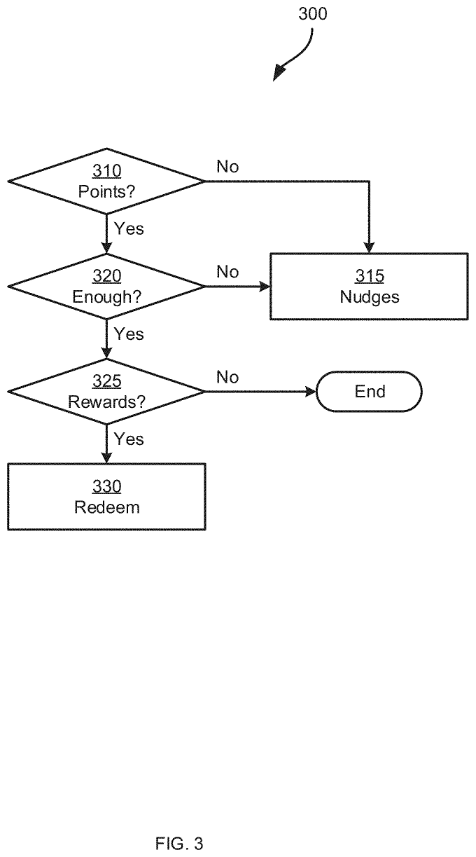

FIG. 3 is a flow chart depicting a part of Match 215 in an example implementation of FIG. 2. Similar to the method in FIG. 2, the example entry point into the method 300 is the identification of a user. That is, the Platform 110 identifies a customer identifier (e.g., based on email address etc. for a guest user or account information for a registered user) associated with the user or customer browsing the e-storefront of the Merchant 140 serviced by the Platform 110. The Platform 110 may then send the customer identifier to the Loyalty Rewards System 120.

The Loyalty Rewards System 120 receives the customer identifier from the e-commerce platform and identifies a point balance associated with the customer identifier. In particular, the Loyalty Rewards System 120 determines whether the point balance for the user satisfies a threshold condition. For example, the threshold condition may be a threshold point balance. If the Loyalty Rewards System 120 determines that the user has reward Points 310 satisfying the threshold condition (e.g., a point balance exceeding the threshold point balance), then the method 300 proceeds to Enough 320.

If the Loyalty Rewards System 120 determines that the user does not have enough reward Points 310, then the method 300 proceeds to generate Nudges 315. In particular, the Nudge module of the Loyalty Rewards System 120 generates encouragement Nudges 315 for presentation to the customer or user to encourage the user to earn reward points (or reward discounts or reward amounts of money) to the user. Example encouragement nudge messages include “Earn 100 reward points for every $10 purchase” (example encouragement) and “Click ‘Allow’ and get $3 off your 1st order” (example amount reward as well as being an interaction).

In some examples, the Loyalty Rewards System 120 may cooperate with the Hub 400 to determine whether the user has sufficient transferrable reward points at other merchants. The Nudges 315 may then present an example message like “You have Marketplace points at other merchants use?” with a “Use Now” button”. By clicking the “Use Now” button, the Hub 400 then converts and transfers sufficient reward points to this merchant for the user to redeem the reward.

Alternatively, instead of nudging the user to use the points at other merchants, the user may set the Hub 400 of the Loyalty Rewards System 120 to automatically convert and transfer sufficient reward points from other merchants to this merchant for the user to redeem the reward.

If the user has reward Points 310 (YES) to satisfy the threshold condition, then the Loyalty Rewards System 120 determines whether or not the user has Enough 320 reward points, or already has a reward like a “$3 off your 1st order”. If the user does not have Enough 320 rewards points, then Nudges 315 would be presented and may include further example messages like “Only need to purchase $37 to earn 10% discount” and “Only need another 25 reward points to qualify for a $10 discount”. If the user does have Enough 320 rewards points, then the Loyalty Rewards System 120 determines the Rewards 325. That is, the Loyalty Rewards System 120 selects a reward option (Rewards 325). The reward option may be, for example, a discount percentage, a discount amount, or the like. The reward option selected based on the largest available reward option, a smallest available reward option, a randomly-selected available reward option, or other criteria. The available reward options may be based on possible redemption options based on the point balance associated with the customer identifier.

The nudge module may then send a nudge (Rewards 325) including the selected reward option for presentation to the customer. For example, the Rewards 325 nudges may include messages such as “Congratulations! You have $5 off your next purchase” with a “Use Now” button to Redeem 330.

The e-commerce Platform 110 and/or the Loyalty Rewards System 120 may then receive a response to the Rewards 325 nudge from the customer or user. If the response indicates that the customer does not wish to apply the reward option (e.g., by closing the nudge or not receiving a response), then the method 300 ends.

If the response includes an indication from the customer to apply the reward option (e.g., the customer clicks the “Use Now” button), then the method 300 proceeds to Redeem 330. The e-commerce Platform 110 may then store the reward option for a subsequent purchase. In response to selection of one or more items for the subsequent purchase, the reward option is applied to the selection.

For example, the e-commerce Platform 110 may determine whether a cart of a current session includes one or more selected items. When the cart includes one or more selected items, the Platform 110 may apply the reward option to the cart (i.e., the current purchase). When there are no items in the cart, the reward option would be applied to the next items in the cart which could be during the same session or a later session when the user returns to the merchant website after, for example, a few days. In some examples, the reward option may be stored by the Platform 110, while in other examples, the reward option may be sent back to the Loyalty Rewards System 120 to store, for example, if the current session ends without the customer making a purchase to which to apply the reward option. An example of applying the $5 off to the purchase is the Loyalty Rewards System 120 entering the discount code for the $5 off for the user.

After the reward option is redeemed at 330, the Loyalty Rewards System 120 updates the point balance associated with the customer identifier, for example in LRS Database 160.

The nudges of Nudges 315 and Rewards 325 may be presented at any of the pages of the merchant's website including the home page and the checkout pages. Further, the nudges of Nudges 315 and Rewards 325 may be presented at the same time at any of the pages of the merchant's website. For clarity, more than one nudge may be presented on one page of a merchant's website at any one time.

FIG. 4 is a block diagram of an example implementation of the Hub 400. The Hub 400 includes an Access Module 410, a Hub Module 420, and a Hub Database 430. The Hub Module 420 further accesses the LRS Database 160 to search for a customer's loyalty reward information and to update the LRS Database 160 with the customer's information that has changed due to redeeming reward points or other activities through the Hub 400. Each module as described herein may be defined by a set of instructions in the hub application, or may be its own distinct application containing instructions executable by a computing device. Each module may preferably be stored on a centralized reward hub server (i.e., in the memory of said server), however in other examples, portions of the hub 400 may be implemented as applications on other servers (e.g., on the platform 110).

The Hub Database 430 stores a plurality of hub accounts and data associated with each hub account, such as customer name, credentials to access the Hub 400, transaction history of the customer using the Hub 400 (such as redemptions of reward points), and customer identifications. In particular, each hub account may be associated with a plurality of customer accounts, where the customer accounts are accounts as identified by individual Merchants 140 on Platform 110 or LRS 120. The hub accounts may be identified based on customer identifiers such as email addresses where the customer has been verified to have access thereto, telephone numbers where the customer has been verified to have access thereto, and customer IDs which may have been verified by others such as the Platforms 110. The associated customer accounts may be identified by the Hub 400 based on the same email address or other customer identifier used for both the hub account and a customer account with a Merchant 140. In other examples, the associated customer accounts may be added by the customer or user. In such examples, the user may be prompted by the Hub 400 to provide verification to access the requested customer account. In this way, the Hub 400 may support group accounts, in which a single hub account may be authorized to access a variety of customer accounts with different merchants, including multiple customer accounts (e.g., associated with different users or customers). Similarly, the same customer account may be associated with multiple hub accounts. The hub database 430 may therefore function as an account database for the hub 400. In some examples, the hub database 430 may be integrated with the LRS database 160. For example, the hub database 430 may be a portion of the LRS database 160. In other examples, the hub database 430 and the LRS database 160 may be independent of one another. In such examples, the hub database 430 and the LRS database 160 may preferably not store overlapping information to reduce duplication of records, and hence, for example, the hub database 430 may be an account database for the hub 400 while the LRS database 160 may be a merchant database for the LRS 120.

The Access Module 410 functions as the gateway into Hub 400 by the customer through their access credentials (such as their username and password) and for each of the customers to create their hub account. The Access Module 410 further on-boards customers onto the Hub 400 by receiving the customer identifications (such as their telephone number and email addresses) from the customers and to verify that the customer has access to their customer identifications using known methods. When the received customer identifications have been verified, the verified customer identifications are stored in the Hub Database 430.

Further, the Access Module 410 permits one hub account to be accessed and controlled by one or more customers where family or group hub accounts may be created. Each customer may have their own access credentials for their one family or group hub account.

The Hub Module 420 implements the operations of the Hub 400 as described in FIG. 1. The functions of the Hub Module 420 further include converting reward points of different loyalty reward programs to normalized reward points, and selecting which merchant's reward points (that the customer has earned) are to be redeemed in priority before another merchant's reward points associated with the same customer.

The normalization of reward points is desired so that the value of a reward point from one merchant is approximately the same as another reward point earned from another merchant. This issue is further complicated where the merchants may be in different countries and as such further adjustments may be considered due to currency exchange rates. The term “reward points” as used in this document means points, but may also be set as a currency such as US dollars (USD). A loyalty rewards program may use, for example, $1 in reward points for every purchase costing $100 instead of 1 reward point for every purchase costing $100.

For normalization, the Hub 400 (and in particular, the Hub Module 410) selects a reference basis and determines an exchange rate for points (ERP) for each merchant based on the reference basis so the reward points of a merchant may be converted to a nominal reference value per reward point. The ERP of a reward point may be based a number of different reference bases such as (1) value of the points from the redemption of rewards (reward value), (2) value of the points from earnings (earning value), or (3) any combination (e.g., a weighted combination) of the reward value and the earning value such as an average based on (reward value+earning value)/2.

In particular, each merchant 140 may define their own ERP based on the redemption options available. The ERP may be set by each merchant in their own interests and may also be adjusted by each merchant at any time. For example, the merchant may adjust the ERP to a lower value to encourage customers to use points from other merchants to purchase from the merchant such as during a sales campaign. In another example, a new merchant may set their ERP to a low value (low as compared to other merchants) in order to encourage customers to use points from other merchants as the new merchant may not have issued many reward points.

Loyalty reward programs frequently provide for earning points for rewards that do not directly correspond to monetary amounts. For example, the value of a 10% discount or free shipping reward may not have a known monetary amount at the time of redemption. Another example, not having a known monetary amount, is earning a 100 points for referring another customer. For such examples of rewards, a fixed monetary amount may be assigned such as the 10% discount being equivalent to a $10 coupon. Similarly, such examples of non-monetary earnings (such as referrals and following on social media) may also be assigned monetary amounts. In other examples, other quantitative bases (i.e., other than monetary) may be provided.

An example calculation using the earning value method for a reward point is a Merchant B having a monetary earning rule of 1 reward point is earned per purchase amount of $10. The ERP is then calculated as one point having a value of $10 based on the required purchase amount divided by the number of points. Where there is also a non-monetary earning rule, such as 100 points for a referral, the assigned monetary amount assigned to a referral may be $100 (or some other arbitrary assignment of a value for referral—e.g., based on an average increased earning amount Merchant B expects to receive from the referral) to derive an ERP of one point having a value of $1 based on the assigned monetary amount divided by the number of points.

In an example of normalization using reward value as a reference basis, there are two merchants: Merchant A and Merchant B. They each have a setup with a single monetary earning rule, and multiple spending or reward rules. For this example, they are both selling and discounting in American dollars (USD).

Merchant A's loyalty rewards program provides: earn 1 point for every $10 spent, where 50 points is needed to redeem a $5 coupon reward and 80 points is needed to redeem a $10 coupon reward. The ERP using the earning value as a reference basis is $10 per point.

While Merchant B's loyalty rewards program provides: earn 2 points for every $10 spent where 100 points is needed to redeem a $6 coupon reward, 140 points is needed to redeem a $12 coupon reward, and 180 points is needed to redeem a $18 coupon reward. The ERP using the earning value as a reference basis is $5 per point.

For Merchant A, redeeming for a $5 coupon costs 50 points (=$5.00/50) where 1 point is worth $0.10 (i.e., the ERP using the reward value as a reference basis is $0.10 per point) and redeeming for a $10 coupon costs 80 points where 1 point is worth $0.13 (i.e., the ERP using the reward value as a reference basis is $0.13 per point).

For Merchant B, redeeming for a $6 coupon costs 100 points where 1 point is worth $0.06 (i.e., the ERP using the reward value as a reference basis is $0.06 per point), redeeming for a $12 coupon costs 140 points where 1 point is worth $0.09 (i.e., the ERP using the reward value as a reference basis is $0.09 per point), and redeeming for a $18 coupon costs 180 points where 1 point is worth $0.10 (i.e., the ERP using the reward value as a reference basis is $0.10 per point). Where there is also a % discount reward, the % discount reward may be assigned a $10 coupon value, for example, and calculated accordingly.

As can be seen, the ERP per point may vary depending on the reward option. Accordingly, the determined ERP for exchange purposes may be set using a number of different methods such as: at the average value of a point, at the highest value of a point, at the lowest value of a point, and any combination thereof where the ERP for exchange purposes may be any combination of the reward point values. For example, if a merchant expects that 90% of rewards points issued will be redeemed based on the monetary reward rules and 10% of rewards points issued will be redeemed based on the non-monetary reward rules, then the determined ERP may be a weighted average of the ERP as calculated based on monetary reward rules (i.e., weighted at 90%) and the ERP as calculated based on non-monetary reward rules (i.e., weighted at 10%). As will be appreciated, the ERP as calculated based on monetary reward rules may further be defined as a weighted average based on the different monetary reward options and expected redemption rates for each reward option. As will be appreciated, similar weighted averages may be applicable to monetary earning rules and non-monetary earning rules.

Returning to the example, for Merchant B; the highest value for a point is $0.10, the lowest value of a point is $0.06, and the average value of a point is $0.08 using ($0.06+$0.10)/2. Other suitable representative values other than the arithmetic mean (e.g., median, mode, weighted averages, etc.) may also be used. Where the arithmetic mean is used, Merchant A has an ERP of 1 point=$0.11 USD and Merchant B has an ERP of 1 point=$0.08 USD.

Once their ERPs have been calculated and set using reward value as a reference basis, Merchants A and B may continue to adjust their earning rules without changing the redemption value of the points. Conversely, once their ERPs have been calculated and set using earning value as a reference basis, Merchants A and B may continue to adjust their reward rules without changing the earning value of the points.

Alternatively, the ERPs of Merchant A and Merchant B may be from any combination of the value of the points from both earning value and reward value as reference bases.

The ERPs for Merchant A and for Merchant B is, for example, associated with the merchants in the LRS database 160. The ERPs may be re-calculated if and when the merchants change their earning rules and reward rules as applicable.

As will be appreciated, the ERPs allow conversion of the points to a common basis (e.g., dollars), and hence allow loyalty rewards points associated with a customer account with Merchant A and loyalty rewards points associated with a customer account with Merchant B to be normalized in the common basis and fairly compared. As described above, the ERPs may be based on different reference basis to define the value of a single point. Additionally, in other examples, the common basis may be a different quantitative amount other than dollars as presented above. For example, the common basis may be the loyalty rewards points of either Merchant A or Merchant B (or another Merchant 140), or a different currency, or another point system basis (e.g., of the Hub 400).

As will be further appreciated, where Merchant A and Merchant B are using different currencies, the ERPs may account for currency exchange rates to obtain equivalent values in the common basis between merchants.

In some examples, the Hub 400 may use an intermediate common basis to convert to prior to completing the conversion to the common basis. For example, since most merchants may define their earning rules and reward rules based on local currency, the local currency may be used as an intermediate common basis, and then the Hub 400 may define an exchange rate from the local currency to another common basis (e.g., Marketplace points, as will be described further below, or the points of a given merchant, etc.).

In some examples, the ERPs and common basis may be used to transfer loyalty rewards points from one merchant to another. In particular, the Hub 400 may facilitate transfers between two customer accounts (e.g., with different merchants) associated with the same hub account.

Where a customer F has 150 Points at Merchant A and wants to transfer them all to Merchant B, the calculation to facilitate this would be the steps: (1) convert the points to USD using (<# of Points at Merchant A>×<Merchant A Exchange Rate>=USD) to have 150×$0.11 USD=$16.50 USD; and (2) convert the US Dollars back to Points using <USD>±<Merchant B Exchange Rate>=Points at Merchant B to result in $16.50±$0.8=206 Points at Merchant B.

Where customer F redeems points of Merchant A for $18 coupon at Merchant B requiring 180 points of Merchant B, the steps are: (1) convert the Points to US Dollars using <Points Cost of Coupon at Merchant B>×<Merchant B Exchange Rate>=USD to result in 180×$0.8 USD=$14.40 USD; (2) Convert the US Dollars back to Points using <USD>±<Merchant A Exchange Rate>=Points at Merchant A to result in $14.40±$0.11=131 Points at Merchant A. 131 points of Merchant A is redeemed at Merchant B for the $18 coupon of Merchant B. For simplicity of illustration, only one merchant's points (Merchant A's points) were used in this redemption example; the points of other merchants may similarly be calculated and used, in addition to those points of Merchant A, in the redemption of the $18 coupon reward of Merchant B.

While the USD is used in this example, any other currency or any “unit” may be used as the intermediate transfer unit. It does not matter which currency or unit is used in the calculations to redeem the points at one merchant for the rewards of another merchant.

In some examples, the transfer and redemption of points between merchants may create friction for customers to consider the math. Accordingly, the Hub 400 may provide a summed or combined total of the amount of reward points so that the customers are dealing with a single, normalized common basis (e.g., a single type of currency or reward point) for all of their redemptions in a Marketplace (i.e., a common platform for merchants and customers, as supported by the Hub 400). The combined total is a proxy currency or proxy points to represent the total reward points of the customer at the merchants. The Marketplace comprises merchants which permit the customers to redeem the points of other merchants at their estore. Once the customer selects where they would like to spend their combined reward points, the Hub 400 processes their request accordingly. The “summed up” or combined reward points may be referred to herein as Marketplace points (MPs).

While the examples as described have shown merchants with either currency or points, the merchants in the Marketplace or in collaboration, in some embodiments, the Marketplace has heterogeneous merchants where some merchants use currency type of reward points and the rest of the merchants use points type of reward points. These heterogeneous Marketplaces may use the ERPs to convert the reward points into the same type of reward points (e.g., the Marketplace points) for a combined total. In other examples, another common basis may be used by the Hub 400.

In a further example, the Hub 400 may aggregate and output a combined total in both a points type and a currency type of reward points. Different exchange rates for points may be used to provide all types of reward points from whatever types of reward points a merchant may use. Such combined totals may have the advantages of both types of reward points.

To further the example; Merchant A has 1 Point=$0.11 USD resulting 9.9 Points=$1.00 USD, Merchant B has 1 Point=$0.8 USD resulting in 12.50 Points=$1.00 USD. When each of these merchants opted-in to Marketplace, there is provided their points to dollar conversion rate (rounded exchange rate): Merchant A has 9 Points=$1.00 USD, and Merchant B has 13 Points=$1.00 USD.

For example, a customer A with 100 points at Merchant A has $11.00 USD (100×$0.11) redeemable value and with 200 points at Merchant B has $16.00 USD (200×$0.8). The combined total would then be $27.00 USD ($11.00+$16.00).

The combined total could be displayed to the customer in a number of different ways including (1) to show the combined total in currency (USD), for example $27.00, of available coupons that they may spend, and (2) to show the combined total in MPs where 1 MP is set at $0.10 USD. The value of one MP may be set at any number, but a convenient value is the average value of the reward points over all of the merchants. In a Marketplace of only Merchant A and Merchant B, the average of $0.11 and $0.80 is rounded to or is approximately $0.10 USD. Setting the value of one MP to $0.10 USD would allow the MPs to approximate the reward points at the merchants in this example.

Where value of one MP is set at $0.10 USD, the 100 points at Merchant A converts to 110 MPs (100×$0.11=$11.00 USD redeemable value divided by $0.10=110 MPs), and the 200 points at Merchant B converts to 160 MPs (200×$0.8=$16.00 USD redeemable value divided by $0.10=160 MP). The combined total of 110 MPs and 160 MPs results in 270 MPs being displayed as the amount points available to be spent or redeemed.

For implementations using actual monetary amounts as the combined total; the customer may expect one dollar deduction for each dollar spent or redeemed, but many merchants have complex redemption rules such as tiered redemption rules where higher spending customers (such as VIPs) have reduced redemption costs. There may not be one dollar deduced for each dollar spent or redeemed unless the Marketplace sets a rule requiring one dollar deduction for each dollar spending. Accordingly, the Hub 400 may use MPs instead of monetary amounts to hide such complex redemption rules as customers may not be expecting one point deduction for each point spent or redeemed.

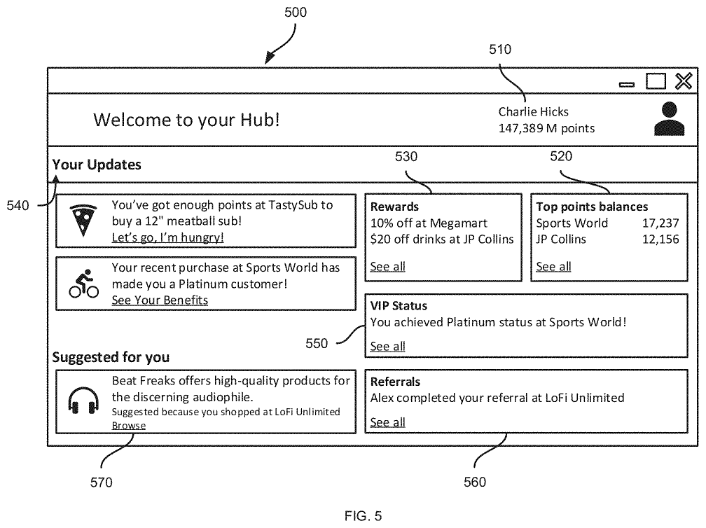

FIG. 5 is a web page displaying the information of a customer by the Hub 400 of FIG. 4 in accordance with an example embodiment. This example embodiment is set up to use MPs where each merchant sets their own exchange rate for points (ERP). By setting their own ERP, the merchants may be able to more flexibly adjust the value of their reward points to match the needs of each of their businesses.

Upon a customer signing into their hub account through the Access Module 410, Hub Module 420 identifies a set of associated customer accounts associated with the hub account using the Hub Database 430. Each associated customer account in the set corresponds to a customer account with one of the merchants on the e-commerce platform 110. Accordingly, the Hub Module 420 may then retrieve data from the LRS database 160 for each associated customer account. In particular, the data retrieved by the Hub Module 420 may include the associated loyalty reward point balances for the customer account. The associated loyalty rewards points for each respective customer account may then be converted to a common basis, such as MPs. In particular, the Hub Module 420 may use the ERPs for each merchant to convert the corresponding loyalty rewards points of the customer account for that merchant. As a result of the conversion, the Hub Module 420 obtains a nominal value representing the associated loyalty rewards points for the customer account in the common basis. The Hub Module 420 may additionally aggregate the nominal values of the respective customer accounts and output the aggregated nominal values.

The resulting information and the combined total MPs are displayed in a Home Screen 500 having sections comprising a Combined Total 510 (displaying “Charlie Hicks” as the customer's name with a combined total MPs of “147,389 M points” and where “Charlie Hicks” and “147,389 M points” are also links to a web page with more details of the combined total MPs), a Top Balances 520 (displaying “Total points balances” with the top merchants and their point balances “Sports World 17,237”, “JP Collins 12,158”, and a link “See All” to full list of merchants where the customer has earned reward points), a Rewards 530 (displaying the “Rewards” available to the customer such as “10% off at Megamart”, “$20 off drinks at JP Collins” with a link “See all” to a list of rewards already owned and available for use by the customer), a Updates 540 (displaying “Your updates” events of the customer with the merchants such as “Your recent purchase at Sports World has made you a Platinum customer” with a link “See your benefits” to Sports World's website), a VIP Status 550 (displaying a list of merchants where the customer has VIP status such as “You achieved Platinum at Sports World” with a link “See all” to the full list of VIP statuses), a Referral 560 (displaying a list of the referral status such as “Alex completed your referral at LoFi Unlimited” with a link “See all” to the full list referrals), and a Suggestions 570 (displaying “Suggested for you” advertisements such as “Beat Freaks offer high-quality products for the discerning audiophile” with a link “Browse” to the merchant Beat Freaks' website).

For example, the combined total MP may be obtained by the Hub 400 normalizing each of the associated loyalty rewards points for each customer account associated with the hub account to a common basis for the Hub 400, namely the marketplace points. The Hub 400 then sums the normalized associated loyalty rewards points to obtain the marketplace point balance in the common basis (i.e., marketplace point balance of 147,389 MPs). The Hub 400 may output the marketplace point balance.

For example, the suggested merchants in the “Suggested for you” region may be obtained by retrieving spending data for the customer accounts associated with the hub account and comparing merchant data (e.g., categorizations of the merchant and the like) from the merchants for which spending data exists (i.e., merchants that the owner of the hub account has shopped at) to merchant data from merchants for which spending data does not exist (i.e., merchants which the owner of the hub account has not shopped at). The Hub 400 may identify suggested merchants based on said spending data and merchant data and output the suggested merchant for display at a client device.

While the webpage of FIG. 5 is typically displayed by a browser on the display of a laptop size computer, it may also be displayed on handheld mobile computers such as where the sections 510 to 570 are displayed in a vertical sequence instead all together on a larger laptop display.

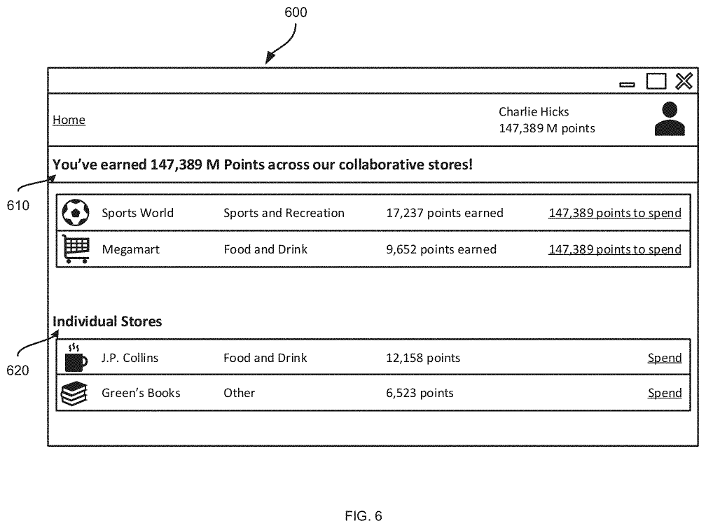

FIG. 6 is a web page, Combined 600, displaying more details of the Combined Total 510 section of FIG. 5. The Combined 600 comprises a Collaborative section 610 and an Individual section 620.

The Collaborative section 610, displayed as “You've earned 147,369 M Points across our collaborative stores!”, shows a listing of the stores or merchants where the merchants permit the reward points earned at their respective stores to be redeemed at other merchants. The list of merchants permitting exchange of loyalty rewards points may be tracked by the Hub 400. An example listed merchant is the store “Sports World” selling “Sports and Recreation” products and services, where the customer Charles Hicks has “17,237 points earned” (this is Sports World's reward points) and where a link “147,369 points to spend” is a web page to redeem the MPs and Sports World's reward points.

The Individual section 620, displayed as “Individual stores”, shows a listing of the stores or merchants where the merchants or stores only allow the redemption of reward points earned at their stores.

An example listed merchant is the store “JP Collins” selling “Food and Drink” where the customer Charles Hicks has earned reward points of “12,158 points”. An associated link “Spend” is also provided for the customer to easily access the web pages for redemption of reward points at the merchant's (JP Collins') website.

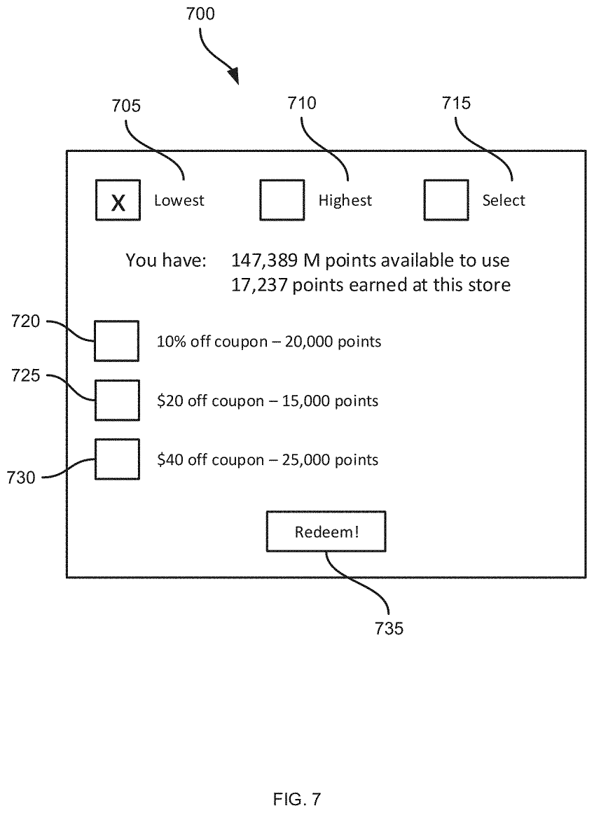

FIG. 7 is a web page, Redemption 700, linked by “147,369 M points to spend” of the collaborative section 610 of FIG. 6 for redeeming the MPs of customer Charles Hicks. The Redemption 700 comprises a Lowest 705 (sorting list of reward point balances at merchants from lowest to highest for transfer of points from lowest), a Highest 710 (sorting list of reward point balances at merchants from highest to lowest for transfer of points starting from highest), a Select 715 (customer manually select the merchants for the points to transfer for this merchant “Sports World”), a 10% off 720 (a “10% off coupon” reward available for redemption at a cost of “20,000 points”), a $20 off 725 (a “$20 off coupon” reward available for redemption at a cost of “15,000 points”), a $40 off 730 (a “$40 off coupon” reward available for redemption at a cost of “25,000 points”), and a Redeem button 735 (customer clicks this button to redeem once the reward desired is selected for redemption)

The reward options provided by the Hub 400 may be based on the marketplace point balance as opposed to the associated loyalty rewards points for the individual merchant. When the customer does not have enough MPs associated with the individual merchant to redeem a reward option, the Hub 400 may initiate a transfer request from other merchants in response to selection of the reward option, and in particular, on the basis of the marketplace point balance. As noted above, the Hub 400 may additionally receive selection of a transfer rule. The Hub 400 selects customer accounts from selected merchants to transfer points according to the transfer rule.

Typically, the customer will have more M points (or MPs) available for redemption than required for redeeming a particular reward, thus only the points from selected merchants need be exchanged and transferred.

Alternatively, a conversion cost may also be added in exchanging the reward points of one merchant for those of another merchant, for example, a fixed number of points may be deducted for each exchange from the merchant whose points are being transferred from. Such a conversion cost may be implemented to encourage using points where they are earned.

Where the customer selects the 10% off 720 coupon for redemption using the Lowest 705 (i.e., an example transfer rule), upon clicking the Redeem button 735, the Loyalty Rewards System 120 (1) sorts the list of merchants by reward point balances from lowest to highest; (2) the reward point balance, starting at the merchant with lowest reward point balance, is exchanged (using the ERP) and transferred to the customer's account at merchant Sport World; and (3) the reward points are exchanged and transferred from the next merchant (to merchant Sport World) on this list until sufficient reward points have been transferred to redeem the selected reward i.e. the 10% off 720 in this case.

If manual selection (i.e., an example transfer rule) of merchants for reward points exchange and transfer is desired then the Select 715 is selected where the Loyalty Rewards System 120 provides a list of merchants for the customer to select for exchange and transfer until sufficient merchants have been selected so that sufficient reward points have been exchanged and transferred for the redemption.

Alternatively, the reward points selected for exchange and transfer are not limited until sufficient reward points have been exchanged and transferred for the redemption. The reward points may be exchanged and transferred freely or with other limitations like only 1000 points may be transferred to a merchant without redeeming any rewards per month.

This web page, Redemption 700, of FIG. 7 is also accessible from Nudge 315 when the customer desires to redeem a reward to be used for a purchase, but does not have sufficient points at the merchant and where the merchant permits reward points earned other merchants to be exchanged and transferred to the merchant for the redemption.

The average customer may have reward point balances with a variety of stores or merchants. In another example using currency MPs, a sample customer Fran has the following point balances at: Boathouse=100 Points (where the merchant has opted-in collaboration or Marketplace with an exchange rate of $0.10 USD/Point), Ivory Ella=300 Points (where the merchant has opted-in collaboration or Marketplace with an exchange rate of $0.8 USD/Point), Sloane Tea=50 Points (where the merchant has opted-in collaboration or Marketplace with an exchange rate of $0.8 USD/Point), Hush Blankets=75 Points (where the merchant has not opted-in to Marketplace or collaboration i.e. reward points earned at other merchants may not be redeem at this merchant), L′Oreal=400 Points (where the merchant has opted-in collaboration or Marketplace with an exchange rate of $0.8 USD/Point), Eight Ounce=200 Points (where the merchant has opted-in collaboration or Marketplace with an exchange rate of $0.9 USD/Point), and Good Vibes=150 Points (where the merchant has not opted-in to Marketplace or collaboration).

When redeeming, customer Fran may only use reward point balances at merchants or stores which have opted-in to the Marketplace or collaboration. Using currency MD (Marketplace dollar), in this example; customer Fran has a combined total balance of $87.00 MD from Boathouse of 100 Points→$10.00 MD (100 points×$0.10 USD/point), Ivory Ella of 300 Points→$25.00 MD, Sloane Tea=50 Points→$4.00 MD, L′Oreal=400 Points→$30.00 MD, and Eight Ounce=200 Points→$18.00 MD.

In this example, customer Fran desires to redeem her reward points at Eight Ounce costing $45.00 MD for the 10% off discount coupon. Since she already has $18.00 MD at the Eight Ounce store, the remaining $27.00 MDs (the target total) needs to be transferred from the other merchants who have opted-in to the Marketplace or collaboration.

The customer Fran may manually select her reward points from a list of reward points at the merchants who have opted-in to the Marketplace or collaboration for transfer to the merchant Eight Ounce in order to redeem the 10% off discount coupon. This method creates more work for the customer and some customers may prefer a method requiring less work.

A low to high method is provided where to transfer from is based on the assumption that a smaller number of points are less “useful” to a customer than a larger number of points at a single store. This is because many loyalty reward programs are structured to prevent fraud, thereby requiring the customer to have made at least a couple purchases before they can redeem.

The low to high method has three steps: (1) sort the available reward point balances from lowest to highest, (2) Subtract from the balance at the top of the list (up to a max of target total), and (3) if more points are still required, repeat steps 1 and 2.

For customer Fran's target total of $27.00 MD at Eight Ounce, the transfers required based on customer Fran's current balances are: (1) sorted listed of balances from lowest to highest of opted-in stores, and (2) transferring from Sloane Tea=50 Points→$4.00 MD ($23.00 MD still needed), Boathouse=100 Points→$10.00 MD ($13.00 MD still needed), and Ivory Ella=300 Points→$24.00 MD but only transfer $13.00 MD (163 points used) as the target total of $20.00 MD is achieved. The remaining reward points are not transferred leaving at Ivory Ella=137 Points→$11.00 MD and L′Oreal=400 Points→$32.00 MD.

In this example, the actual number of points subtracted from each merchant would be computed based on [currency-backed normalization] such at Ivory Ella, each point is worth $0.8 USD, and $13.00 worth of value is needed for transfer, 13÷0.8=162.5 Points (rounded to 163) should be subtracted.

Once the transfer is complete, customer Fran's balances would be: Sloane Tea=0 Points, Boathouse=0 Points, Ivory Ella=137 Points, L′Oreal=400 Points, and Eight Ounce=500 Points→$45.00 MD.

Once the transfer is complete, customer Fran redeems her 500 Points for the 10% off discount at Eight Ounce.

Alternatively, a high to low method is used which has three steps: (1) sort the available reward point balances from highest to lowest, (2) Subtract from the balance at the top of the list (up to a max of target total), and (3) if more points are still required, repeat steps 1 and 2. Further, the list of reward point balances may be sorted into random order. It will be understood that there are other known methods to sort the list of reward point balances.

Alternatively, a black list and white list of accounts or merchants may further be incorporated into the list of merchants who are part of the collaboration or Marketplace. For example, the reward points on black list of accounts are not to be taken for exchange and transfer except manually by the customer, and reward points on white list of accounts may be taken for exchange and transfer. Such black list may be selected from a list of merchants (not shown).

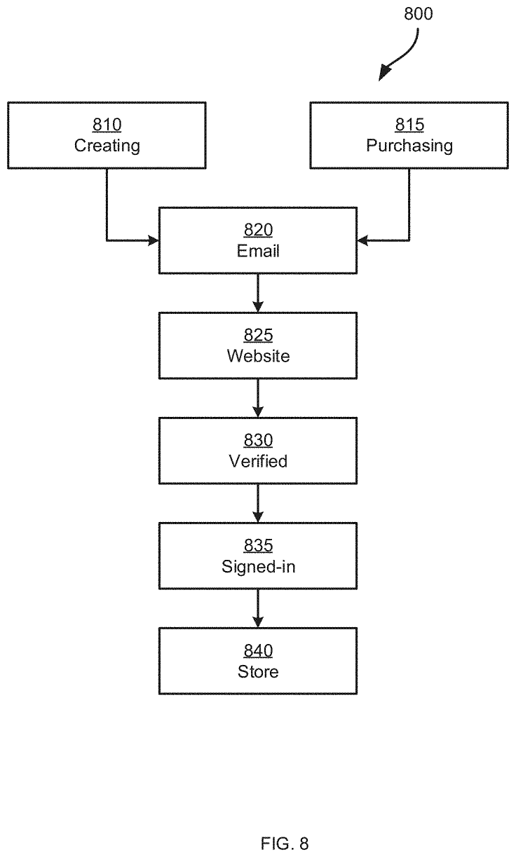

FIG. 8 is a flow chart depicting a Method 800 of implementing a part of the Loyalty Rewards System 120 in accordance with another example embodiment. For example, the method 800 may be performed via execution of the loyalty reward application and/or the hub application and/or the e-commerce platform application by an appropriate processor other device capable of executing computer-readable instructions. In other examples, the method 800 may be performed by other suitable devices and/or systems.

In the example depicted in FIG. 8, there may be two entry points by users into the Hub 400 of the Loyalty Rewards System 120. A first entry point is a guest user Creating 810 a new account with a merchant or with the Marketplace of the Hub 400. A second entry point is a guest user or a user with an account at a merchant Purchasing 815 a product or service from the merchant.

After purchasing 815, the Loyalty Rewards System 120 may receive purchase data including a customer identifier from the e-commerce platform 110. The Loyalty Rewards System 120 may then determine whether the hub database 430 includes an existing entry corresponding to the customer identifier. When the hub database 430 does not include the customer identifier as an existing entry, the Loyalty Rewards System 120 may create a new entry in the hub database 430 for the customer identifier. That is, the Loyalty Rewards System 120 may automatically index each customer identifier based on purchases made at merchants 140 who subscribe to the Loyalty Rewards System 120.

The Loyalty Rewards System 120 may further store, in association with the customer identifier, login parameters for the customer identifier. For example, when the customer is a registered user (i.e., having a username and password for the customer's account with the merchant 140), then the Loyalty Rewards System 120 may obtain account credentials for the customer identifier. In particular, the account credentials may be the credentials associated with the purchase data used by the customer to make the purchase. The Loyalty Rewards System 120 may index the obtained account credentials as login parameters associated with the customer identifier in the hub database 430. In other examples, rather than obtaining account credentials, or when the customer does not have account credentials (e.g., is a guest user), then the Loyalty Rewards System 120 may store a guest user indicator as the login parameters associated with the customer identifier.

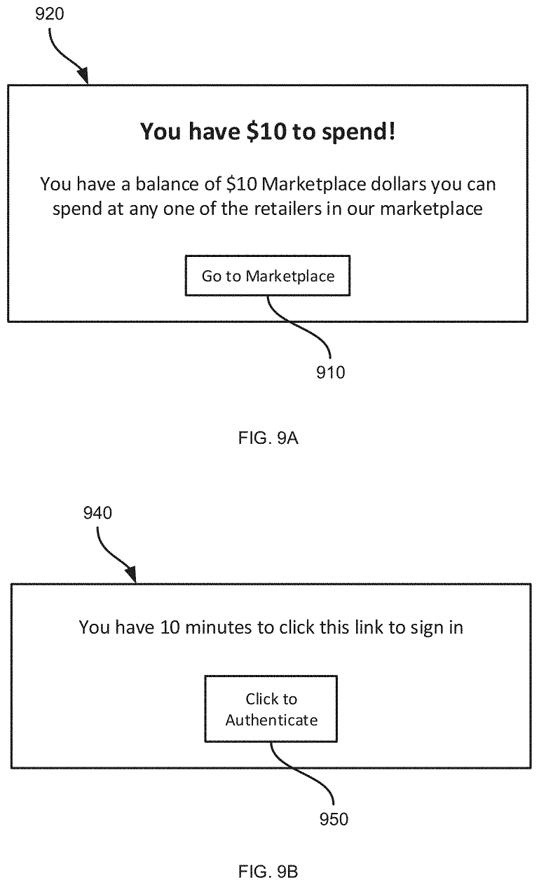

As part of completing the Purchasing 815 of the product or service, a message confirming the purchase is sent to the user or guest user. The message is by Email 820 in this implementation. Other messaging services may be used such as SMS (Short Message Service) instead of email. The Email 820 includes a Link 910 (see FIG. 9). The Link 910 is a URL (Uniform Resource Locator) address for directing the browser of the user to a Website 825 of HUB 400. That is, the Loyalty Rewards System 120 may send the customer a login link for the hub 400 based on the new entry or the existing entry corresponding to the customer identifier in the hub database 430.

Preferably, the login link may facilitate sign-in by users to the Website 825 (i.e., for the Hub 400) without requiring that users re-enter their account credentials, such as a username and password for registered users/accounts and/or an email address for guest accounts. Thus the login link may automatically provide a reference to the Hub 400 as to the user's credentials to reduce the number of client/server interactions and the amount of processing by the Loyalty Rewards System 120.

For example, the Website 825 may allow sign-in by users with accounts with select merchants such as merchants who are a part of Marketplace using the same access credentials. For example, where a merchant and the marketplace share access credentials, accessing the login link and redirecting the user to the Website 825 may automatically sign the user in to the Marketplace or Hub 400 via an embedded token, authentication code or the like providing the Loyalty Rewards System 120, and in particular the hub 400 with the required information to allow the registered user to be automatically signed in. That is, the authentication code may pass the user's account credentials to the Website 825 when the website 825 is accessed via the login link. For security, the user's account credentials may be encrypted (e.g., hashed) and stored as a token which is passed to the Website 825. In other examples, the token need not be directly representative of the account credentials, but may simply be a uniquely generated token representing the customer identifier to facilitate login. For example, upon the user selecting the Link 910, the user's browser is directed to the Website 825 and the user is requested to sign-in unless the user's browser has been set to automatically sign-in where the user has an account on the Website 825. Further, where the hub database 430 includes account credentials as login parameters for the entry in the database, the Loyalty Rewards System 120 may provide the stored account credentials to the website 825.

In other examples, where the user does not have sign-in credentials for the Website 825, such as guest users; the user may be Verified 830 as being in control of an email address associated with reward points or Marketplace points (authenticated). That is, the login link may trigger guest user email verification based on the login parameters associated with the customer identifier is the guest login indicator.

For example, FIG. 9A is a screenshot 920 of the link 910 depicting a part of the message of email 820 in accordance with the embodiment of FIG. 8. In this implementation, the Link 910 is a button with the words “Go to Marketplace”. When the user clicks the button to activate the URL link, the user's browser is directed to the Website 825. The email 820 may additionally contain further information to encourage the user to access and spend their marketplace or hub points. For example, the email 820 may display “You have $10 to spend!” and “You have a balance of $10 Marketplace dollars you can spend at any one of the retailers in our marketplace” or “You have 500 Marketplace points you can spend at any one of the retailers in our marketplace”, or other suitable alternatives and/or combinations of the above. That is, the email 820 may reference a dollar value (e.g., based on the ERP for the marketplace point balance of the account), or the marketplace points, or the like. The rest of the message of Email 820 may contain messages such as confirming a purchase with the details of the purchase, and confirming the automatic creation of an account at the Marketplace of the Hub 400, in particular when a new account was created (i.e., indexed and added to the hub database 430 based on the purchase data) as a result of the purchase from the merchant.

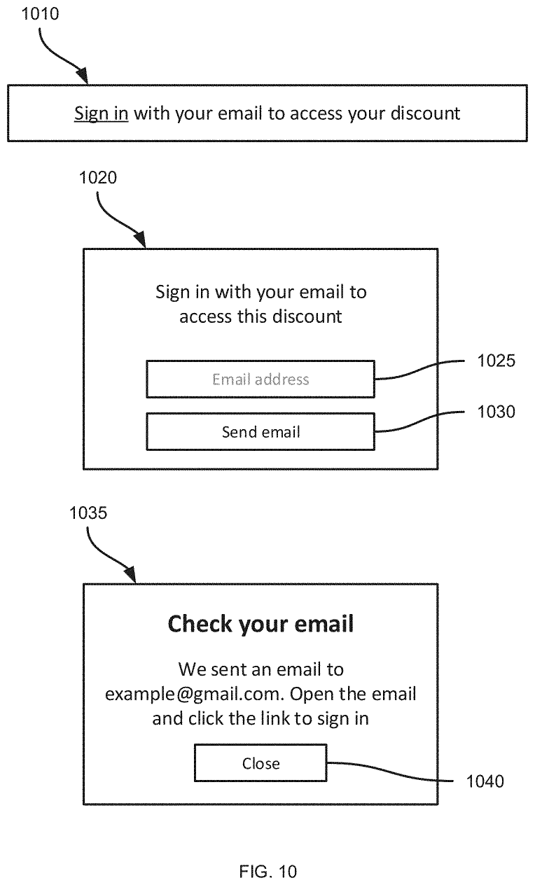

FIG. 10 are screenshots of Website 825 of the Hub 400 in accordance with the embodiment of FIG. 8 where the user does not have sign-in credentials for Website 825, such as guest users. Such users need to be Verified 830 (authenticated) as being in control of an email address associated with reward points or Marketplace points. There are a number of known methods of email authentication. This method authenticates the email address of the user while also acting as access credentials for accounts (including accounts of guest users).

For Verified 830; at Website 825, the user is provided with a Sign-in 1010 block having “Hello! Sign in with your email to access your discount”. The user by selecting “Sign in” is provided with an Email Entry 1020 having “Sign in with your email address to access your discount”, a Field 1025 to enter an email address, and a Send 1030 to submit the email address to the Hub 400 where Hub 400 determines if the submitted email address is associated with a guest account. If the submitted email address is not associated with a guest account then security measures may be taken such as not responding to the submitted email address and blocking such requests from the IP address of the submitting device.

In other examples, the login link 910 may include an authentication code or embedded token or the like providing the user's email address to the Loyalty Rewards System 120 when the Website 825 is accessed, and hence the Loyalty Rewards System 120 may skip the sign-in 1010 block. That is, the authentication code may pass the user's email address to the centralized reward hub 400 (or Loyalty Rewards System 120) when the website 825 is accessed via the login link. For security, the user's email address may be encrypted or hashed into the embedded token which is passed to the centralized reward hub.

If the Hub 400 determines that the submitted email address is associated with a guest account then the Loyalty Rewards System 120 generates a first authentication code. This first authentication code is inserted as an authentication cookie onto the user's device (one of the Client 130 computing devices) using known methods for placing a cookie onto such devices. A second authentication code is generated and incorporated into an Authentication Link 950 and this link is sent in an Authentication Email 940 to the submitted email address, or to the email address encoded into the embedded token.

FIG. 9B is a screenshot of an Authentication Link 950 depicting a part of the message of Email 940 in accordance with the embodiment of FIG. 8. The Email 940 sent to example@gmail.com, as the submitted and/or encoded email address in this example, has the Authentication Link 950 shown as a “Click to Authenticate” button and has text “You have 10 minute to click this link to sign in”.

The Hub 400 then Notifies 1035 the user with the message “Check your email we have sent an email to example@gmail.com” and “Open the email and click the link to sign in” in a pop up (in this example) on Website 825. The Notifies 1035 is also provided with an optional Close 1040 to remove this pop up message.

Upon receiving the Email 940, the user opens the email and clicks the Authentication Link 950 which link is interpreted by the embedded application of the Loyalty Rewards System 120 in the browser of the user's device to provide the first authentication code and the second authentication code to the Loyalty Rewards System 120 for authentication determination.

The Loyalty Rewards System 120 performs authentication determination with Determine (1) if the first authentication code is the same as the second authentication code, and with Determine (2) if the Authentication Link 950 has not expired. The expiration is based on whether the Authentication Link 950 was clicked or selected by the user within a limited time period (such as 10 minutes) of the email being sent to example@gmail.com and when the second authentication code is received by the Loyalty Rewards System 120. The limited time period may be measured by other methods such as whether the authentication cookie has expired.

If both Determine (1) and Determine (2) are determined by the Loyalty Rewards System 120 as YES then the guest user is authenticated as being associated with the guest account of example@gmail.com and the Signed-in 835 website of Hub 400 is provided to the user's browser with the user's information such as the user's amount of Marketplace points. This would be the user being signed into their account at the Signed-in 835 website of Hub 400.

If any of Determine (1) and Determine (2) is determined by the Loyalty Rewards System 120 as NO, then the user is prevented from logging into the guest account associated with the email address officeaction@gmail.com at the Hub 400 and a message indicating such may be displayed to the user.

Alternatively, for enhanced security, the first authentication code and the second authentication code may be encrypted using any number of known methods. The Determine (1) would therefore decrypt the first authentication code and the second authentication code accordingly.

Further alternatively, for enhanced security, the first authentication code and the second authentication code are different numbers, such as random computer generated numbers, which are stored in the Loyalty Rewards System 120. The Determine (1) then determines whether the stored numbers match the first authentication code and the second authentication code accordingly for a YES.

Further alternatively, for enhanced security, the first authentication code is a random computer generated number and the second authentication code indicates where a copy of the first authentication code is stored in the Loyalty Rewards System 120. The Determine (1) then determines whether the stored number matches the first authentication code for a YES.

Further alternatively, for enhanced security, where the email address entered to log into a guest account is not an email address in the Loyalty Rewards System 120 associated with a guest account (this guest user does not exist in the Loyalty Rewards System 120), the embedded app of the Loyalty Rewards System 120 a inserts a dummy cookie into the user's device in order not to expose whether the email address has an account in the Loyalty Rewards System 120 to hackers. A check your email message may optionally also be displayed on the user's device.

Further alternatively, for only some security, the Authentication Link 950 is not checked against the authentication cookie, nor is a cookie inserted onto the user's device. The Verified 830 only uses Determine (2) to see if the Authentication Link 950 has not expired.

Once the user has been authenticated by Verified 830, the Website 825 is shown in state Signed-in 835 where details associated with the user are displayed such as the amount or estimated amount of Marketplace points.

The Signed-in 835 website has a list of merchants (which are links to the merchant websites) where the user's Marketplace points may be used. Upon one of the links to a merchant website or store, the user's browser is directed to the Store 840, the selected merchant's website where the user may redeem their marketplace points for use in purchasing their merchant's products or services.

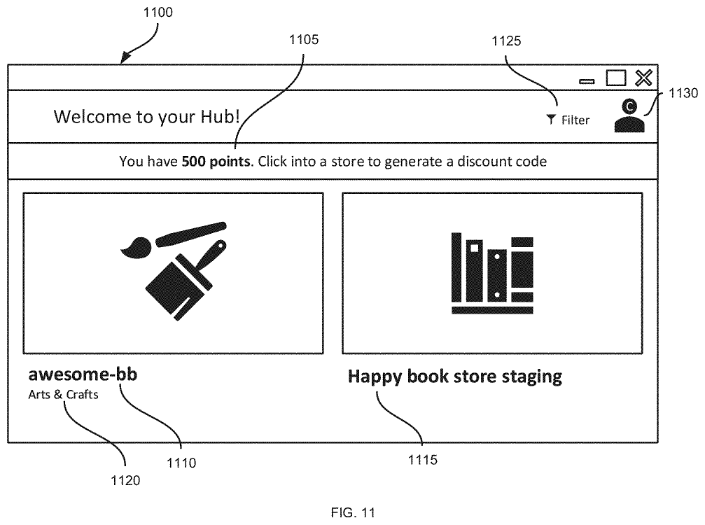

FIG. 11 is a screenshot of the Signed-in 835 website of the Hub 400 in accordance with the embodiment of FIG. 8. In particular, the Loyalty Rewards System 120 provides the centralized reward hub interface 1100 (i.e., the website 825 and more particularly, the website 825 in a signed-in 835 state) for display at the client 130. The Signed-in 835 website comprises a Points 1105 field showing the available Marketplace points of the user as “You have 500 Points. Click into a store to generate discount codes”; a Merchant 1110 “awesome-bb” store; a Merchant 1115 “Happy book store staging” store; a Category 1120 “Arts & Crafts” indicating the type (or categories) of stores being shown; a Filter 1125 for selecting other types of stores to be shown in at the interface 1100; and an Identifier 1130 to indicate that the user has been signed into the Marketplace of the Hub 400.

The links of the Merchant 1110 and the Merchant 1115 are links which the user may select a store 840 (i.e. click) in order to be directed to the website of the merchant store. Each of the Merchant 1110 “awesome-bb” store and the Merchant 1115 “Happy book store staging” store has their own loyalty reward program where the reward points of each merchant may be used at the other store through Marketplace points. In other examples, other Merchants 140 may also be displayed for selection.

The Loyalty Rewards System 120 may then receive a selection of one of the merchants displayed at the centralized reward hub interface 1100 (e.g., from a user interaction at the client device 130) and may then redirect the client device to a corresponding merchant website for the selected merchant.

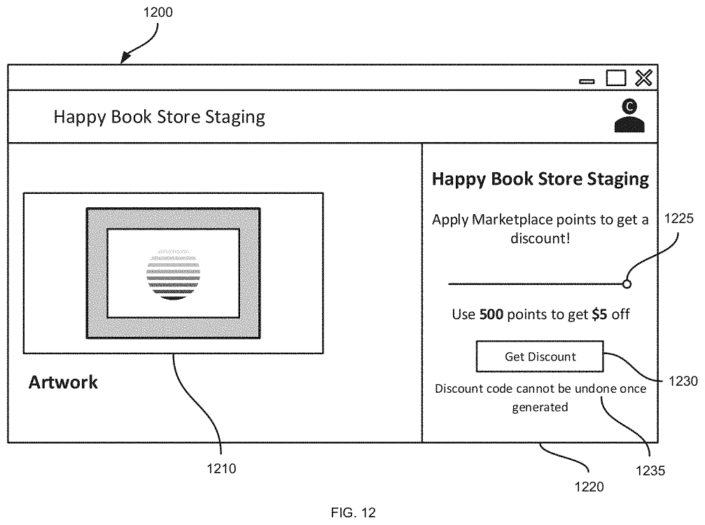

For example, FIG. 12 is a screenshot of a merchant website 1200 of the Store 840, the Merchant 1115 “Happy book store staging” store, in accordance with the embodiment of FIG. 11. The Store 840 comprises products for sale such as an Art 1210 “Artwork”, and a Redemption 1220 section for the user to redeem their points.

Preferably, the user is signed into Store 840 upon being directed there by the link of Merchant 1115 from the centralized reward hub interface of the Loyalty Rewards System 120. To be in this signed in state; the user credentials, including the amount of Marketplace points, may be sent to Store 840 using a number of different methods including the Loyalty Rewards System 120 (which includes the Hub 400) communicating the account credentials to the Store 840 via the Platform 110 (which hosts the website of Store 840). For example, the Loyalty Rewards System 120 may retrieve the account credentials stored in the hub database 430 in association with the customer identifier logged into the centralized reward hub 400. The retrieved account credentials may be sent to the merchant website (i.e., as hosted by the platform 110) upon redirection of the client device 130 to the merchant site. In particular, the link to the merchant site may include an authentication code or embedded token, or similar to allow automatic sign in when the client device 130 is redirected to the merchant site. For example, the account credentials may be hashed or otherwise encrypted into the authentication code or embedded token, or the authentication code or embedded token may be otherwise uniquely generated to represent the specific customer identifier.

The platform 110 may additionally host a discount module portion of the Loyalty Rewards System 120 (i.e., as an application stored on the platform server and executed by the platform server processor to integrate the discount module application with the merchant website). In particular, in such examples, the discount module may be integrated with the merchant site. Thus, the Loyalty Rewards System 120 may particularly send the account credentials to the discount module integrated with the merchant website 1200.

The discount module is illustrated as Redemption 1220 in FIG. 12 and in this example, has a Slider 1225 to redeem “$5 off 500 points” when the slider 1225 is moved to an end to redeem the full 500 points of the user or a lesser amount of points for a smaller discount. Once the Slider 1225 is set, the Get Discount 1230 button may be clicked (e.g., by the user at the client device 130) to generate the discount code for the user. The “Discount code cannot be undone once generated” 1235 warning is also provided at the Store 840. In some examples, the warning 1235 may be displayed in a pop-up window after the Get Discount 1230 button is selected and may be accompanied by a confirmation button to confirm that the discount code should be generated.

In other examples, other suitable discount options may also be displayed by the discount module. For example, rather than the slider 1225, the discount module may include radio buttons, text fields for manual entry, combinations of the above, and the like. In particular, the discount options provided by the discount module may be based on the point balance for the account received from the hub 400.

Having Redemption 1220 discount module integrated at the Store 840 has a number of advantages including the user may redeem their Marketplace points at the Store 840 as and when the user decides to purchase a product or service at the store, and further does not need to redeem their Marketplace points at another website such the website of the Hub 400 or at the website of another store where the points of the another store are converted to the 500 Marketplace points for use at the Store 840.

In response to receiving the selection of a discount option (i.e., the user clicking on the Get Discount 1230 button, in conjunction with the position of the slider 1225 on the slider bar), the discount module generates a discount code usable at the merchant site 1200. Thus, the discount module may cooperate with the platform 110 to generate a suitable discount code accepted by the platform 110 to provide a discount for the merchant. In some examples, in addition to receiving the account credentials and account point balance from the hub 400, the discount module may additionally receive the ERP for the conversion from marketplace point value to merchant point value from the hub 400. The discount module may thus convert the point balance of marketplace points to a merchant point balance of merchant points based on the ERP and send the merchant points to be applied to get the discount code to the platform 110 and/or the merchant 140 as applicable.

After generating the discount code for the merchant, the discount module may decrement the point balance for the account (i.e., reduce the point balance by the number of marketplace points used) and return the updated point balance to the hub 400 after application of at least a portion of the point balance to apply the discount at the merchant site. The hub 400, in turn, may update the point balance for the account in the hub database.

In some examples, in addition to sending the updated point balance, the discount module and/or the platform 110 may send purchase data for a subsequent purchase which applies the discount code to be recorded by the hub 400.

In other examples, rather than having the discount module integrated with the merchant site, the discount module application may be hosted at the loyalty reward server, and the discount module as described above may be integrated with the Hub 400 website. That is, the hub 400 may generate a discount code for use at the merchant site.

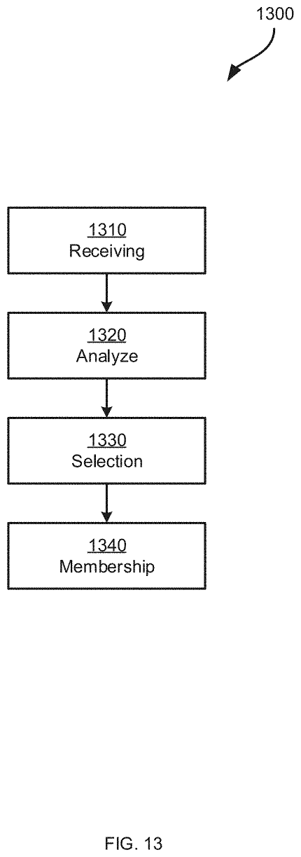

FIG. 13 is a flow chart depicting a Method 1300 of limiting users to certain loyalty reward programs in accordance with another example embodiment. A loyalty reward program with their associated reward points or reward currency may be subject to the laws of various jurisdictions. It could be difficult to fully comply with the laws of multiple jurisdictions, thus it is advantageous to limit users to only certain loyalty reward programs suitable for them. This may be particularly applicable when the user is Creating 810 a new account with the hub 400 directly.

The Method 1300 comprises Receiving 1310, Analyze 1320, Selection 1330, and Membership 1340. At Receiving 1310, the Loyalty Rewards System 120 (and in particular, the hub 400) may receive a new hub account request, for example, from the client 130. In order to create the new hub account, the Loyalty Rewards System 120 may obtain user parameters associated with the new hub account request. For example, the information of the user who wishes to join a loyalty reward program is entered by the user and received by the Loyalty Rewards System 120. For example, a new user may enter their information at a web page of Hub 400 in Creating 810 an account at Marketplace Hub 400. Such information may include the new user's geographic location, the user's demographics, the user's interests, and the like. In some examples, some of the user parameters may be determined automatically, using a number of known methods including the new user's entered physical address and location information determined from the new user IP address. That is, the Loyalty Rewards System 120 may detect some of the user parameters based on an IP address of a client device (e.g., the client device 130) from which the new hub account request originated.

In some examples, the user parameters may be collected and sent with the new hub account request, while in other examples, the Loyalty Rewards System 120 may prompt collection of the user parameters in response to the new hub account request.

The Loyalty Rewards System 120 Analyzes 1320 the information of the new user and provides a list of loyalty reward programs suitable for the new user. In particular, the Loyalty Rewards System 120 filters a list of merchants based on the user parameters. In some examples, the list of merchants from which merchants are filtered may simply be a list of merchants which subscribe to the Loyalty Rewards System 120. In other examples, the list of merchants from which merchants are filtered may be based on merchants subscribed to the Loyalty Rewards System 120 which have also pre-authorized the Loyalty Rewards System 120 to allocate points (e.g., marketplace points, as converted from merchant points), for example to provide a welcome or sign-up bonus. In still further examples, the list of merchants from which merchants are filtered may be based on merchants subscribed to the Loyalty Rewards System 120 which have also pre-authorized the Loyalty Rewards System 120 to create a merchant account on behalf of a customer.

The list of merchants may then be filtered based on the user parameters, for example to filter the merchants having a matching geographic location such as within the same city, region, state, or country. This list may include multi-jurisdiction loyalty reward programs which comply with the legal requirements of more than one jurisdiction and which comply with the legal requirements applicable to the location or jurisdiction of the new user. Other user parameters may also be used to filter the list of merchants to obtain a filtered list, for example based on general categories of interest of the user.

For Selection 1330, the new user selects from the list of suitable loyalty reward programs provided by the Hub 400 (i.e., from the filtered list of merchants).

Upon receiving the selection 1330, the hub 400 may send a new merchant account request to the selected merchant to create a merchant account for the new user. In order for the new merchant account to have the user's desired login parameters, prior to sending the new merchant account request, the hub 400 may additionally obtain login parameters from the user. For example, the login parameters may include account credentials (i.e., username and password, email address, etc.), or an indicator designating the account as a guest account with a provided email address, or the like. In particular, the hub 400 may request a specific set of login parameters based on the types of accounts (e.g., registered, guest), and other fields required for account creation by the selected merchant. The Loyalty Rewards System 120 may therefore store merchant-specific login parameter types in the loyalty reward database 160.

Thus, upon receiving the selection 1330, the hub 400 retrieves the login parameter types from the loyalty reward database 160 and requests the login parameters from the user (e.g., via the client 130). The hub 400 may then send the new merchant account request to the selected merchant (e.g., via the platform 110) on the new user's behalf using the login parameters obtained for the new user. The new user may be sent a confirming email, or confirming message from another communication service, of their Membership 1340 with information for the new user. The information may include the user's new account information. The information may additionally include a point balance for the merchant account (i.e., in merchant points) or for the hub 400 (i.e., in marketplace points) for signing up with the merchant and/or the hub 400.

Accordingly, in addition to sending the new merchant account request to the new merchant, the hub 400 may also index a new hub account in the hub database 430 (i.e., the account database for the centralized reward hub 400). The new hub account may include the same login parameters as the login parameters obtained for the new merchant account, so as not to request additional login parameters for the hub 400. The new hub account may be associated with any sign-up bonus attributed to the account by the selected merchant on behalf of the hub 400. That is, the hub 400 may allocate the predefined number of merchant points to the hub account. The merchant points may be converted to marketplace points based on the ERP for the merchant.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

The scope of the claims should not be limited by the embodiments set forth in the above examples but should be given the broadest interpretation consistent with the description as a whole.

1. A server comprising:
a memory storing an account database for a centralized reward hub;
a processor interconnected with the memory, the processor configured to:
receive purchase data for a purchase by a customer, the purchase data including a customer identifier;
determine whether account database includes an existing entry corresponding to the customer identifier;
when the account database does not include an existing entry corresponding to the customer identifier, create a new entry for the customer identifier; and
send the customer a login link for the centralized reward hub based on the new entry or the existing entry corresponding to the customer identifier.

2. The server of claim 1, wherein the processor is configured to receive the purchase data from an e-commerce platform server managing a plurality of merchant e-storefronts.

3. The server of claim 1, wherein the processor is further configured to:
when the account database does not include an existing entry corresponding to the customer identifier, obtain account credentials for the customer identifier, the account credentials associated with the purchase data; and
store the account credentials as login parameters associated with the customer identifier in the new entry.

4. The server of claim 1, wherein the processor is further configured to:
when the account database does not include an existing entry corresponding to the customer identifier, store a guest login indicator as login parameters associated with the customer identifier in the new entry.

5. The server of claim 1, wherein the login link includes an authentication code to facilitate login to the centralized reward hub for the customer identifier when the login link is accessed.

6. The server of claim 5, wherein the authentication code passes account credentials for the customer identifier to the centralized reward hub to facilitate the login.

7. The server of claim 5, wherein the authentication code passes an email address associated with the customer identifier to the centralized reward hub to facilitate a guest user login.

8. The server of claim 5, wherein the authentication code passes a uniquely generated token representing the customer identifier to facilitate the login.

9. The server of claim 1, wherein the login link is embedded in a message to the customer confirming the purchase.

10. The server of claim 9, wherein the message comprises an email message or a text message.

11. A method comprising:
storing an account database for a centralized reward hub;
receiving purchase data for a purchase by a customer, the purchase data including a customer identifier;
determining whether account database includes an existing entry corresponding to the customer identifier;
when the account database does not include an existing entry corresponding to the customer identifier, creating a new entry for the customer identifier; and
sending the customer a login link for the centralized reward hub based on the new entry or the existing entry corresponding to the customer identifier.

12. The method of claim 11, further comprising receiving the purchase data from an e-commerce platform server managing a plurality of merchant e-storefronts.

13. The method of claim 11, further comprising:
when the account database does not include an existing entry corresponding to the customer identifier, obtaining account credentials for the customer identifier, the account credentials associated with the purchase data; and
storing the account credentials as login parameters associated with the customer identifier in the new entry.

14. The method of claim 11, further comprising:
when the account database does not include an existing entry corresponding to the customer identifier, storing a guest login indicator as login parameters associated with the customer identifier in the new entry.

15. The method of claim 11, wherein the login link includes an authentication code to facilitate login to the centralized reward hub for the customer identifier when the login link is accessed.

16. The method of claim 15, further comprising passing, via the authentication code, account credentials for the customer identifier to the centralized reward hub to facilitate the login.

17. The method of claim 15, further comprising passing, via the authentication code, an email address associated with the customer identifier to the centralized reward hub to facilitate a guest user login.

18. The method of claim 15, further comprising passing, via the authentication code, a uniquely generated token representing the customer identifier to facilitate the login.

19. The method of claim 11, wherein the login link is embedded in a message to the customer confirming the purchase.

20. The method of claim 19, wherein the message comprises an email message or a text message.
